(19) United States
(12) Patent Application Publication
(10) Pub. No.: US 2019/0060031 A1
(43) Pub. Date: Feb. 28, 2019

(54) Dental Throat Dam

(71) Applicant: BOARD OF REGENTS OF THE UNIVERSITY OF TEXAS SYSTEM, Austin, TX (US)

(72) Inventors: Gargi MUKHERJI, Houston, TX (US); Ralph COOLEY, Houston, TX (US)

(21) Appl. No.: 16/116,501

(22) Filed: Aug. 29, 2018

Related U.S. Application Data
(60) Provisional application No. 62/551,243, filed on Aug. 29, 2017.

(51) Int. Cl. A61C 5/82

(52) U.S. Cl. CPC A61C 5/82

(57) ABSTRACT

Disclosed is a dental dam configured for positioning in a mouth of a dental patient to prevent foreign objects from entering the patient's throat. The dam includes a central portion having a convex top edge that may be positioned adjacent to the patient's palate and a bottom edge positioned adjacent to the patient's tongue. Transition portions extend outwardly from the central portion and have a reduced height so that they may be positioned in the patient's retromolar area. Outer wing portions extend outwardly from each transition portion and have rounded edges for positioning inside the patient's cheek. The dental dam also includes an elastomeric reinforcement positioned in the central portion of the dam and having a reduced thickness toward the edges of the dam, such that the edges of a dam are more pliable and the central portion of the dam is more rigid.

### CROSS REFERENCE TO RELATED APPLICATION(S)

This application claims a benefit of priority from U.S. Provisional Application No. 62/551,243, filed Aug. 29, 2017, entitled “Dental Throat Dam,” which is fully incorporated by reference herein for all purposes.

### BACKGROUND

### Technical Field

The disclosure relates to the field of dentistry, and more particularly to removable appliances for protecting the throat during dental or medical procedures.

### Related Art

Patients reclining in a dental chair during the performance of a dental procedure may swallow or ingest crowns, teeth, implant parts, cotton, gauze, or other debris. The debris may ultimately find its way into a lung or other systemic organ, thereby potentially causing serious complications. Potential complications are not limited to pneumothorax, hemorrhage, respiratory distress, or partial airway obstruction, but may also include patient morbidity and mortality. The June 2014 issue of FEDERAL PRACTITIONER reports that in the U.S. alone, over 2,700 patients, including more than 300 children, die of foreign body aspiration each year. Mahmoud et al. reported in Article No. 798163 of CASE REPORTS IN MEDICINE (2012) that foreign bodies can remain undetected for months. Many foreign bodies are incidentally seen when radiographic imaging is ordered for symptoms mistakenly attributed to other medical conditions, including asthma and recurrent pneumonia. If a diagnosis of foreign body aspiration is delayed, a retained foreign body may also result in lung abscess or bronchiectasis.

Various devices have been proposed to address the problem of debris ingestion. For example, U.S. Pat. No. 4,889,491, entitled “DENTAL THROAT SHIELD,” issued on Dec. 26, 1989 to Krygier et al., discloses a shield that is an accessory to a device primarily intended to hold the mouth open during a dental procedure. The Krygier et al. device includes a pair of support members 12 and troughs 24 (FIG. 3).

Another example of such a device is disclosed in U.S. Pat. No. 7,140,881, entitled “PROTECTIVE THROAT SCREEN FOR DENTISTRY,” issued on Nov. 28, 2006 to Gealon. The Gealon device may be “sufficiently flexible” to permit insertion into the patient's mouth but possess “sufficient stiffness” that it will “partially unflex,” thereby providing a biasing force “to hold the throat screen in place” (Col. 3, lines 39-45).

U.S. Pat. No. 7,938,644, entitled “TONGUE RETRACTOR AND FLUID/PARTICLE BARRIER,” issued on May 10, 2011 to Sabbagh, discloses an additional throat shield device that appears to be a relatively large, “kidney-shaped” sponge having a thickness of approximately 5 millimeters (Col. 2, line 59-Col. 3, line 10).

A gauze-supporting frame is disclosed in U.S. patent application Ser. No. 09/923,619, filed on Aug. 7, 2001 by Owais. FIG. 19 discloses an “extraoral” device with fixtures abutting the ears and chin. The intraoral version of the Owais shield includes a plurality of hooks and rings which attach to the teeth, as shown, for example, in FIGS. 16 and 20.

Finally, U.S. Pat. No. 7,293,990, entitled “INTRAORAL DEVICE,” issued on Nov. 13, 2007 to Hirsch et al., discloses a throat shield formed as part of a fluid evacuation device.

### SUMMARY

Disclosed are dental throat dams configured for positioning in a mouth of a dental patient in order to prevent foreign objects from entering the patient's throat during a dental procedure. The dams have a generally planar shape and may be constructed of an elastomeric material. The dams may include a central portion, two transition portions extending outwardly from the central portion, and two outer wing portions at each distal end of the dental dam. The transition portions have a smaller height such that they may be positioned inside a patient's retromolar area to secure the dam in place during a dental or medical procedures involving the oral cavity by preventing accidental aspiration or ingestion of materials. The dam may also include mounting holes to in the outer wing portions to help secure it in place. These holes can also facilitate the attachment of floss or string-like material to ease retrieval of the device. The central portion of the dam has a plurality of small vent holes that are configured to facilitate the patient's breathing, while at the same time prevent the passage of foreign objects into the patient's throat.

The central portion of the dental dam may have a convex or arched top edge that may be positioned adjacent to the patient's palate and a bottom edge that may be positioned adjacent to the patient's tongue. The transition portions have opposing concave edges that form the reduced height and help secure the dam in the patient's retromolar area. The outer wing portions have rounded edges for positioning inside the patient's cheek while avoiding irritation.

The dental dam also includes an elastomeric reinforcement positioned over the central portion of the dam with a variable thickness. The reinforcement is thicker toward the central regions of the dam and thinner towards the outer edges of the dam, such that the edges of the dam are more pliable and the central portion of the dam is more rigid. The reinforcement also has a reduced planar height at the transition portion of the dam, so that the dam may be folded for positioning in the retromolar area, and then spring back into position to protect the patient's throat.

### BRIEF DESCRIPTION OF THE DRAWINGS

Hereinafter, examples of dental dams will be described with reference to the drawings.

FIG. 1 is a front view of a patient's mouth with a dental dam positioned in the patient's retromolar area, behind the most posterior molars or the most posterior tooth.

FIG. 2 is a side view of a patient's mouth with a dental dam positioned in the patient's retromolar area, behind the most posterior molars or the most posterior tooth.

FIG. 3 is a front view of a dental dam.

FIG. 4 is a top view of a dental dam.

FIG. 5 is a side view of a dental dam.

FIG. 6 is a partial front outline view of a medium dental dam.

FIG. 7 is a partial front outline view of a small dental dam

FIG. 8 is a partial front outline view of a large dental dam.

### DETAILED DESCRIPTION

Examples of dental dams and their various features are now explained more fully with reference to certain non-limiting features that are illustrated in the accompanying drawings and detailed in the following description. Descriptions of well-known materials, manufacturing techniques, parts, and equipment are omitted. It should be understood, however, that the detailed description and the specific examples, while indicating preferred examples or embodiments, are given by way of illustration only and not by way of limitation. Various substitutions, modifications, additions and/or rearrangements within the spirit and/or scope of the underlying concepts will become apparent to those skilled in the art from this disclosure.

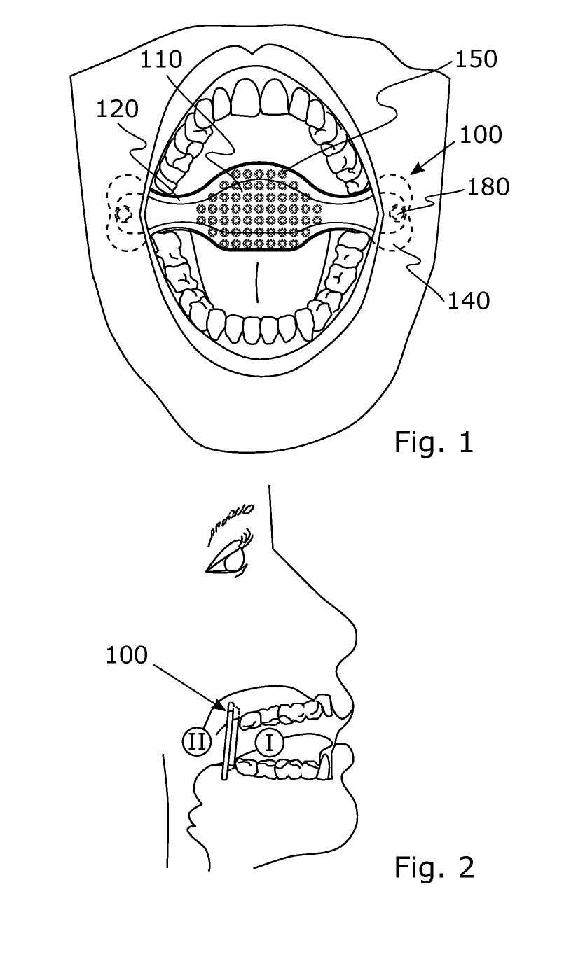

FIGS. 1 and 2 illustrate a dental dam 100 positioned in a patient's retromolar area, behind the most posterior molars. As shown in FIG. 2, the dam 100 divides the patient's oral cavity into a first region I that is in front of the dam 100 and a second region II that is behind the dam 100. The first region I defines a volume which includes substantially all or most of the teeth and the tongue, while the second region II includes the entrance to the throat. The dam 100 substantially reduces access to the throat, thereby reducing the possibility that any sort of foreign object or particulate matter will enter the throat during a dental procedure. In this manner, the dental dam 100 may be positioned entirely within a patient's mouth and permit complete closure of the mouth during a dental procedure.

FIG. 1 illustrates a front view of a patient's mouth with a dental dam 100 positioned so that the entrance to the throat is shielded. Dental dam 100 may be a substantially planar member that may be constructed of an elastomeric material so that it may be deflected from an initial planar configuration during placement inside a patient's mouth, and then spring back to a substantially planar shape when positioned at the desired location. The dam 100 includes a central portion 110, two transition portions 120 that extend outwardly from the central portion 110, and outer wing portions 140 at each distal end of the dental dam 100. The central portion 110 includes a plurality of vent holes 150 sized to prevent foreign objects and debris from entering a patient's throat while still allowing the patient to breathe.

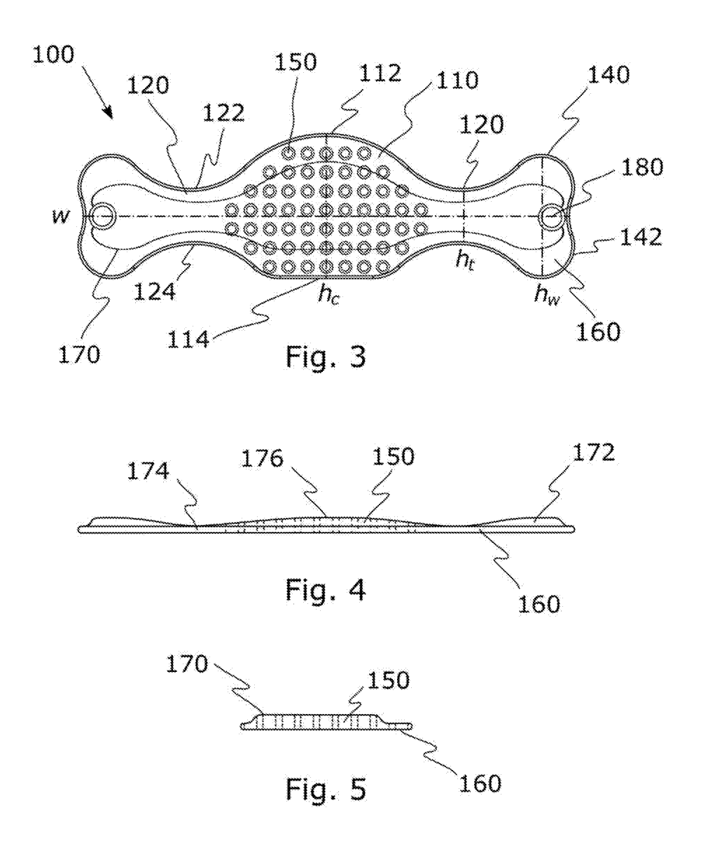

Referring to FIGS. 1-3, the top edge 112 of the central portion 110 may be concave or arched, so that when the dam 100 is positioned inside a patient's mouth the top edge 112 generally follows the interior contour of the patient's palate. The bottom edge 114 of the central portion 110 may be substantially flat, so that when the dam 100 is positioned in a patient's mouth, the bottom edge 114 may be substantially flush with and rest comfortably against the patient's tongue. Vent holes 150 provide a sufficient airflow so that the patient's breathing is unrestricted, but at the same time, are sufficiently small that foreign objects do not pass the dam 100 and move into the patient's throat or airway. By way of example, the plurality of vent holes 150 may be arranged in a series of rows and columns parallel to the bottom edge 114, as shown in FIG. 3. In this example, the diameter of each vent hole may be about 0.08 inches.

Two transition portions 120 extend outwardly from both lateral sides of the central portion 110 and are configured to fit snugly in the patient's retromolar area in order to secure the dam 100 in place during dental or medical procedures involving the oral cavity (such as but not limited to excision of oral lesions, parotid gland surgery, etc. To accomplish this, as shown in FIG. 3, the transition portions 120 may have opposing upper and lower concave rounded edges 122, 124 which provide the transition portions 120 with a reduced height (hₜ) as compared to the height (h_{c}) of the central portion 110 or to the height (h_{w}) of the outer wing portions 140. The concave edges 122, 124 facilitate maintaining position of the dam 100 in a patient's retromolar area.

The outer wing portions 140 may be independently deflected within the patient's mouth so as to position the top edge 112 against the patient's palate, the bottom edge 114 against the patient's tongue, the concave transition edges 122, 124 behind the patient's retromolar area, and the outer wing portions 140 inside the patient's buccal vestibule (cheek), so that the central portion 110 shields the patient's throat area. To avoid irritating the inside of the patient's cheek, the outer wing portions 140 may form a rounded planar edge 142 extending along the planar height (h_{w}) of the outer wing portions 140.

Small mounting holes 180 may be formed in the outer wing portions 140 to permit anchoring the dam 100 to the patient's teeth. By way of example, the mounting holes 180 may be centered on the longitudinal axis w (FIG. 3) and may have a sufficient diameter to secure the dam 100 using dental floss.

As shown in FIGS. 3-5, the dam 100 may also include an elastomeric reinforcement portion 170. Reinforcement portion 170 maintains the shape of the dam 100 during use, while still permitting deflection or bending of the dam 100 during placement in the patient's mouth, as well as avoiding potentially uncomfortable pressure points where the dam 100 contacts the patient's tissue (e.g., at edges 112, 114, 122, 124, and 142). To accomplish this, the reinforcement portion 170 may extend along a central portion of the dam 100, leaving more pliable and less rigid exterior planar edges 160 positioned around the exterior of dam 100. By the same token, the interior of the dam 100 will be stiffer, such that the central portion 110 will tend to remain in place protecting the patient's throat, despite small movements by the patient or unintended contact by a dental instrument.

As shown best in FIG. 4, the reinforcement portion 170 may have a planar thickness that gradually increases toward the interior regions of the dam 100 and decreases toward the exterior regions of the dam 100. For example, the thickness of reinforcement portion 170 may be lesser in area 174 (on the transition portion 120) than in area 172 or 176 (on the outer wing portion 140 or on the central portion 110, respectively). The reinforcement portion 170 may also have a smaller planar height at area 174, in the transition portion 120 as illustrated in FIG. 3. In this configuration, the dam 100 will tend to fold most easily at the transition portions 120 when subjected to out-of-plane forces.

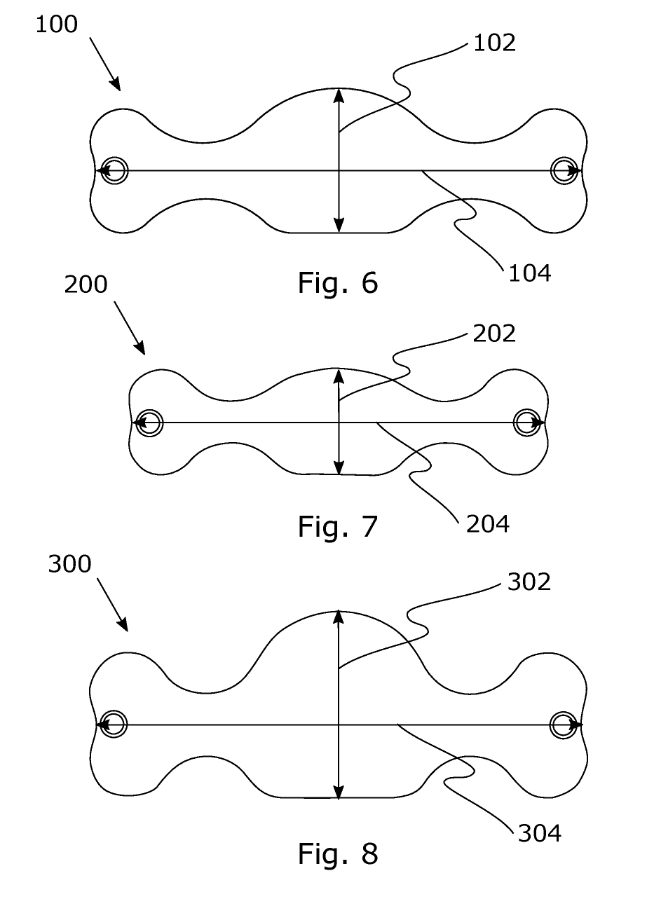

Typically, the dam 100 is constructed in several different sizes in order to accommodate different patients without the need to further modify the dam 100 for a particular patient or procedure. FIGS. 1-5 illustrate an example of a medium-sized dental dam 100. FIGS. 6-8 are simplified outline views of the medium-sized dental dam 100 from FIG. 1-5, as well as a small dental dam 200 and a large dental dam 300. The small and large dams 200 and 300 have altered dimensions, but may otherwise include the same features and construction as the medium dam 100. FIGS. 6-8 depict a planar width along axes 102, 202, and 302, and a planar height along axes 104, 204, and 304 (corresponding to height (h_{c}) in FIG. 3). The following table provides a comparison of the overall width and the height of the central portion for each size dam:

| | Small | Medium | Large |
|---|---|---|---|
| Central Height (in.) | 1.000 | 1.378 | 1.772 |
| Overall Width (in.) | 3.970 | 4.724 | 4.724 |

Dental dam 100 may be disposable and inexpensively manufactured. The dam 100 may be constructed of numerous types of elastomeric materials, such as plastic or silicon materials, which permits the dam 100 to be molded as a single piece not requiring additional finishing steps. The dam 100 may also be constructed of a sponge or sponge-like material, which presents a solid barrier to debris but is sufficiently porous to permit the free flow of air through the dam 100. The dam 100 may also be constructed of a metal screen or fabric mesh, such as nylon, which would also form an air-permeable debris barrier. Laminated cardboard with suitable vent holes 150 may also be used to construct a dam 100. Each of these materials also lends itself to trimming the dam 100 to the correct size for an individual patient.

It is to be noted that various modifications or alterations can be made to the above-described examples without departing from the technical features of the inventions as defined in the appended claims.

What is claimed is:

1. An apparatus comprising:
a substantially planar, elastomeric dental dam having a planar width extending in a direction of a width axis, the dam being configured for positioning in a mouth of a patient to prevent foreign objects from entering the patient's throat, the dental dam comprising;
outer wing portions at both distal ends of the width axis, the outer wing portions each forming a rounded planar edge extending along a planar height, such that the rounded planar edges face the inside of the patient's cheek when the dam is positioned in the patient's mouth;
transition portions extending inwardly from each of the outer wing portions, the transition portions having a transition planar height that is less than the planar height of the outer wing portions, such that the transition portions are configured to be positioned in the patient's retromolar area;
a central portion between the transition portions, the central portion having a convex top edge for positioning adjacent to a palate of the patient's mouth, and a bottom edge for positioning adjacent to a posterior surface of the patient's tongue; and
a plurality of vent holes formed in the central portion such that the patient's breathing is not obstructed when the dental dam is positioned in the patient's mouth.

2. The apparatus of claim 1 wherein the bottom edge of the central portion is substantially flat, so that when positioned in a patient's mouth it rests flush with the patient's tongue.

3. The apparatus of claim 1 wherein the transition portions form an upper concave, rounded planar edge above the width axis and an opposing lower concave, rounded planar edge below the width axis.

4. The apparatus of claim 1 wherein the outer wing portions each form a mounting hole that extends through the dental dam.

5. The apparatus of claim 1 formed of an elastomeric material comprising plastic, rubber, or silicon materials.

6. The apparatus of claim 1 formed of a material comprising laminated cardboard.

7. The apparatus of claim 1 further including an elastomeric reinforcement portion that extends in the direction of the width axis.

8. The apparatus of claim 7 wherein the elastomeric reinforcement portion has a greater planar thickness near a center of the central portion than toward the top and bottom edges of the central portion, such that a planar interior of the central portion is stiffer than a planar exterior of the central portion.

9. The apparatus of claim 7 wherein the elastomeric reinforcement portion extends along the planar width of the dental dam from one wing portion to the other wing portion.

10. The apparatus of claim 7 wherein the elastomeric reinforcement portion has a smaller planar height at the transition portion than at the center of the central portion.

11. The apparatus of claim 7 wherein the elastomeric reinforcement portion has a variable planar thickness, wherein such planar thickness is smaller at the transition portion than at the central portion or at the wing portions, such that the dental dam tends to fold at the transition portions when subject to out-of-plane forces.

12. An apparatus comprising:
a dental dam configured for positioning in a mouth of a patient to prevent foreign objects from entering the patient's throat, the dam comprising;
a central portion having a convex top edge for positioning adjacent to a palate of the patient's mouth, and a bottom edge for positioning adjacent to a posterior surface of the patient's tongue;
transition portions extending outwardly from the central portion, wherein the transition portions have a lower height such that they are configured for positioning in the patient's retromolar area;
outer wing portions extending outwardly from the transition portions at both distal ends of the dental dam, such that the outer wing portions are configured for positioning inside the patient's cheek; and
elastomeric reinforcement positioned on an interior region of the central portion, such that a planar interior region of the central portion is stiffer than a planar exterior of the central portion.

13. The apparatus of claim 12 further comprising a plurality of vent holes formed in the central portion such that the patient's breathing is not obstructed when the dental dam is positioned in the patient's mouth.

14. The apparatus of claim 13 wherein the vent holes extend through at least a portion of the reinforcement portion.

15. The apparatus of claim 12 wherein the elastomeric reinforcement portion extends along a width of the dental dam from one wing portion to the other wing portion.

16. The apparatus of claim 12 wherein the bottom edge of the central portion is substantially flat, so that when positioned in a patient's mouth it rests flush with the patient's tongue.

17. The apparatus of claim 12 wherein the outer wing portions have a height that is greater than the height of the transition portions.

18. The apparatus of claim 12 wherein the elastomeric reinforcement portion extends to at least a portion of the outer wing portions.

19. The apparatus of claim 18 wherein the elastomeric reinforcement portion extends to at least a portion of the transition portions.

20. The apparatus of claim 19 wherein the elastomeric reinforcement portion has a variable planar thickness, wherein the thickness is smaller at the transition portion than at the central portion or the wing portions.
